(19) United States
(12) Patent Application Publication
(10) Pub. No.: US 2004/0200858 A1
(43) Pub. Date: Oct. 14, 2004

(54) Procedure, apparatus and system for controlled dispensing of a prepared medium capable of flowing

(75) Inventors: Roman Kappeler, Muri (CH); Beat Schoch, Oberrueti (CH)

Correspondence Address: BROWDY AND NEIMARK, P.L.L.C., 624 NINTH STREET, NW, SUITE 300, WASHINGTON, DC, 20001-5303, US

(73) Assignee: ROBATECH AG, Muri (CH)

(21) Appl. No.: 10/777,645

(22) Filed: Feb. 13, 2004

(30) Foreign Application Priority Data
Feb. 15, 2003 (DE) 103 06 387.0

(51) Int. Cl. B67D 5/62

(52) U.S. Cl. 222/146.5

(57) ABSTRACT

Apparatus for use in a system which dispenses, for example, adhesive capable of flowing, that melts with increasing temperature. The apparatus includes a container (10) to receive adhesive and a melting device (19, 25) to induce the rise in temperature, so that part of the adhesive is changed into a fluid state. An outlet zone (19) is provided, having at least one passageway (20) for the adhesive capable of flowing. In the outlet zone (19) a cooling device (19, 26, 27) is provided, for the purpose of cooling the passageway (20) after a proportion of the adhesive capable of flowing has flowed out through the passageway (20)

The present application claims benefit of the priority of the German patent application No. 10306387.0 filed on Feb. 15, 2003.

### DESCRIPTION

Apparatus for application in a system that makes available a medium capable of flowing (e.g. adhesive or sealant), together with a system and procedure for making available a medium capable of flowing.

1. Domain of the Invention

This invention relates to apparatus, systems and procedure for making available a medium capable of flowing, especially adhesive or sealant.

2. Background to the Invention and Prior Art

Many industrial processes employ adhesives, sealants and the like which have to be applied to or sprayed in liquid form on to workpieces. The components of such an application system are typically a duct unit in the form of a heatable hose unit, through which the mass capable of flowing is impelled out of a container into a dispensing unit, and a dispensing unit connected to this duct unit, for example in the form of a spray gun.

Adhesives and sealants with viscosity that varies over time at constant temperature are customarily delivered to the user in solid form or in a state of high viscosity and are put into a container which generally has a wide opening at the top. The adhesive or sealant then has to be rendered fluid, generally by the application of heat, before being extracted from its container. Examples of such systems can be found in the German utility model registration DE 201 04 697 U1 and German published application DE 44 18 068 A1. The German utility model registration DE 201 04 697 U1 concerns an apparatus with an adhesive vessel that can be heated. Specifically, it concerns a system of application by rollers whereby the melted adhesive enters directly into the adhesive head and is thence fed to a roller. In one form of embodiment, a cooling process is provided which comes into operation when the supply container is to be changed. German published application DE 44 18 068 A1 primarily concerns a spray nozzle with an output zone that can be cooled, in order to obtain a homogeneously applied adhesive layer.

In general, after the container has been filled with adhesive or sealant, it is equipped with a device known as a follower plate whose outline corresponds to the inner surface of the container, and which is lowered into the container through its opening. The sealant is then heated, and under the pressure exerted by the follower plate and/or the action of a feed pump, it moves out of the container through the duct unit to the place where it is to be used, while the follower plate gradually sinks lower and lower in the container.

The processing of such media is not without its problems, as suitable substances are often subject to drastic changes in their capacity to flow (viscosity), for example through changes in temperature and pressure. Suitable substances may also be subject to changes in viscosity over time at constant temperature. Some of these substances are also sensitive to humidity, as in the case of moisture-induced cross-linking substances. Furthermore, some of these substances display changes in viscosity as the medium ages. Yet other substances display certain changes in their characteristics when they are heated repeatedly, or if they are exposed to humidity.

For some time now polyurethane glue (PUR) in particular has come into use as an adhesive with special qualities. In PUR, cross-linking is already beginning to occur at quite low temperatures (about 40° C.). The higher the temperature of the PUR rises, the faster it cross-links, while viscosity increases. This also happens when no moisture is present. PUR has the further disadvantage that moisture, such as ambient moisture, causes acceleration of the cross-linking process. This leads to a variety of problems. One example is the high cost of cleaning the container and all the components. For example, PUR glue must on no account be allowed to harden in the container or other parts of the system, as it cannot be rendered fluid again, or because repeated melting alters the characteristics of the PUR. These glues also pose problems because their processing can generate toxic vapours, which can cause diseases of the respiratory tract or the skin. For this reason, certain maximum admissible concentrations (MAC values) have to be respected.

Another critical factor is that adhesives or sealants, once melted, need to be used as soon as possible, otherwise their quality deteriorates. Unnecessary heating of the medium has a negative effect on its characteristics.

For these reasons, it is an object to create an apparatus and associated systems which will heat only so much medium as is required for each operation.

It is a further object that the apparatus and associated system should be easy to clean, in case the medium has nevertheless hardened in the apparatus or system.

It is an object of the invention to devise a procedure according to which only so much medium is melted as is required.

### SUMMARY OF THE INVENTION

The object is accomplished by means of an apparatus according to claim 1, a system according to claim 10 and a process according to claim 14.

The dependent claims present additional advantageous forms of embodiment of the invention.

### DRAWINGS

Further characteristics and advantages of the invention are described in detail below, with examples of embodiments and reference to the drawings. All figures are diagrammatic in form and not to scale, and corresponding elements in the construction bear the same reference numbers from one figure to another, even if they may differ in detail. The figures show the following:

FIG. 1 a first form of embodiment of the invention in side view;

FIG. 2 a cross-section of the first form of embodiment of the invention;

FIG. 3 a top view of the first form of embodiment of the invention;

FIG. 4 a schematic cross-section of another form of embodiment of the invention;

FIG. 5 a block diagram of the heating apparatus according to the invention;

FIG. 6 a temperature diagram according to the invention;

FIG. 7 a possible circulating cooler according to the invention.

### DETAILED DESCRIPTION OF THE EMBODIMENTS

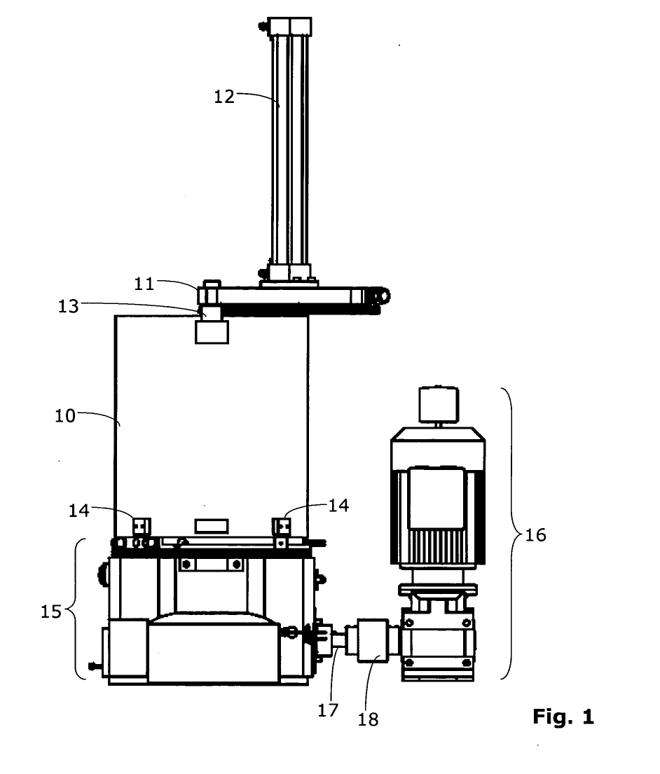

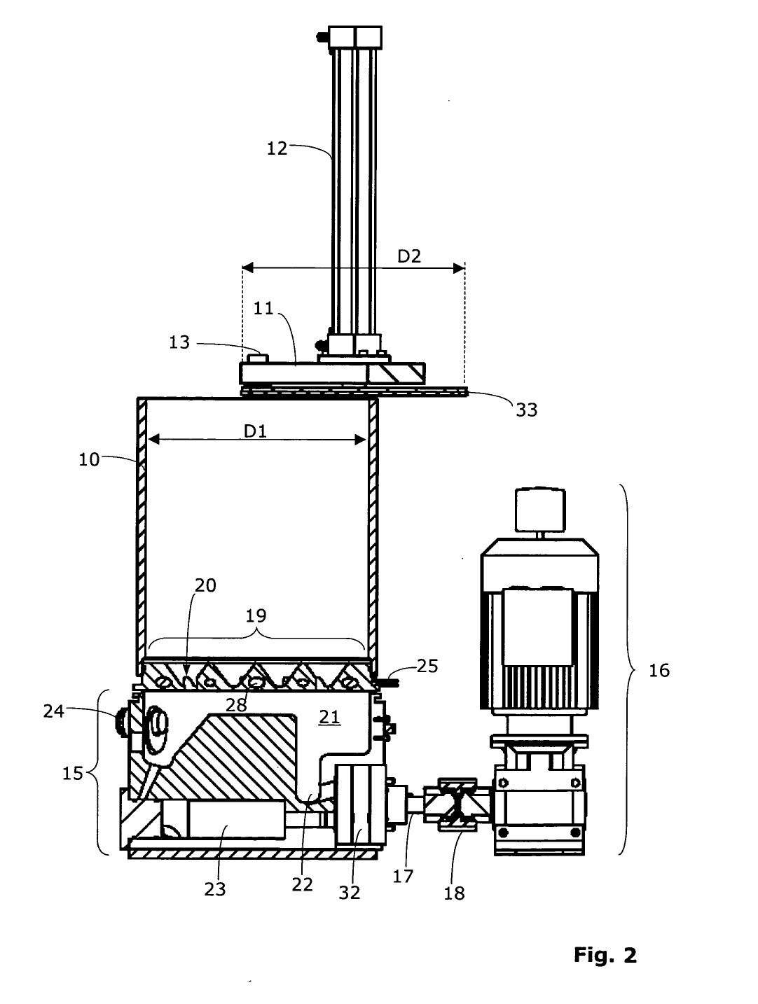

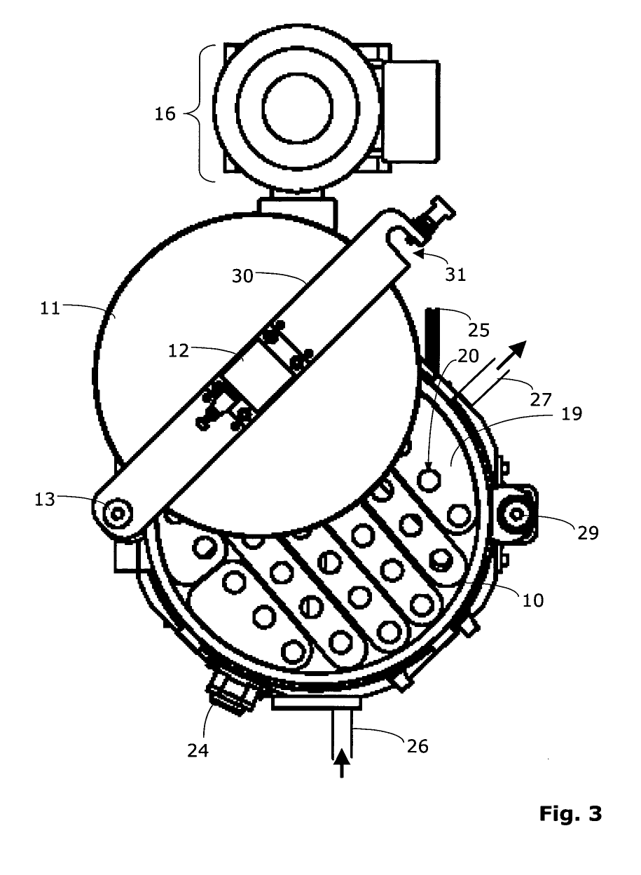

The invention concerns an apparatus for use in a system that processes a medium (e.g. adhesive), as shown for example in FIGS. 1 to 3. FIG. 1 is a side view of the elements of a system that processes a medium (e.g. adhesive). FIG. 2 shows a cross-section through the system and FIG. 3 a top view of the system. The system is designed to process media that, upon an increase in temperature, undergo a change into a state of lower viscosity, thus increasing the fluidity of the adhesive. The apparatus includes a container 10, for example in the form of a cylindrical adhesive tank to receive the medium (for example, PUR-granulate or PUR-blocks). The container 10 is provided with a melting device which engenders a local temperature rise in the medium, in order to bring part of the medium into a state of lower viscosity.

In the present embodiment, the melting device is incorporated in a grill 19, located in the lower part of the container 10. The grill 19 is provided with means for heating, with which the temperature of the grill 19 can be increased in a controlled manner. For this purpose the grill 19 may be equipped, for example, with one or more heating cartridges 25. The grill 19 forms an outlet zone with at least one passageway 20 for the part of the medium with lower viscosity. The apparatus is characterized in that a cooling device 26, 27 is provided in the outlet zone so that the passageway 20 of the grill 19 can be actively cooled, after a proportion of the medium with lower viscosity has passed through the passageway 20. In the embodiment shown, the cooling device includes an inlet opening 26 and an outlet opening 27. These openings 26, 27 are connected to a system of channels 28 (see FIG. 2), which traverse the grill 19. For example, a pump may be provided which brings coolant via the inlet opening 26 through the channels 28 of the grill 19. The coolant then flows out of the cooling device through the outlet opening 27. The channel or channels according to the invention are preferably between 5 mm and 20 mm in diameter. A diameter between 7 mm and 10 mm has proved particularly effective. Channels with the greatest possible interface area with the material of the grill 19 are most suitable, as heat exchange is thereby improved. For this purpose, the channels may be provided with windings, for example.

The cooling device should preferably incorporate a cooling system in the form of a refrigeration compressor, a heat exchanger or a Peltier cooler, for example. As a heat exchanger, an air/water heat exchanger, for example, is suitable. The heated coolant, after flowing through the passageway zone, is led through a radiator block. A fan blows ambient air through this radiator block, thus cooling the coolant. The waste heat is dissipated in the environment. The heat exchanger should preferably include a coolant tank. A pump impels the coolant out of the tank through the channels 28 of the grill 19. An advantage of such a heat exchanger is that it is environmentally friendly, due to its closed circuit. A heat exchanger used in conjunction with the invention will preferably have an output between 50 Watt and 10 kWatt and a throughput capacity between 0.5 I/min and 20 I/min. Particularly suitable is a heat exchanger with an output between 100 Watt and 500 Watt and a throughput capacity between 1 I/min and 5 I/min.

Instead of an air/water heat exchanger, an air/oil, water/water, or air/air heat exchanger may also be used.

As a refrigeration compressor, an example of a suitable device is a system in which a cooling coil is cooled in a tank of coolant by means of the refrigeration compressor. A temperature regulator monitors the temperature of the coolant and controls its circulation. The pump impels coolant through the channels 28 of the grill 19. A refrigeration compressor used in combination with the invention will preferably have an output between 100 Watt and 6 kWatt and a throughput capacity between 0.5 I/min and 30 I/min. A refrigeration compressor of output between 100 Watt and 500 Watt and throughput capacity between 1 I/min and 5 I/min is particularly suitable.

As a Peltier cooler, a suitable device, for example, includes Peltier elements directly connected to a coolant tank. The Peltier elements cool the coolant in accordance with the required cooling performance. The waste heat from the Peltier cooler is released into the environment by means of air/water. Control is preferably effected as a function of tank temperature. By this means, the voltage supply of the Peltier elements can be controlled. Due to this a very good stability of temperature and load matching is achieved. A pump impels the coolant in a closed circuit through the channels 28 of the grill 19. A Peltier cooler used in conjunction with the invention should preferably have an output between 20 Watt and 1 kWatt and a throughput capacity between 0.5 I/min and 20 I/min. A Peltier cooler with output between 100 Watt and 200 Watt and a throughput capacity between 1 I/min and 5 I/min is particularly suitable.

Instead of a closed circuit cooling device, an open circuit cooling device can also be used. For this purpose, the cooling device may be connected, for example, to a water main from which water is taken and pumped through the channel or channels in the grill. The pressure in the water main may be sufficient to drive the water through the channel or channels, depending on the application.

Depending on the construction and dimensions of the device, the incoming coolant in the channel or channels may have a temperature between 5° C. and 40° C. The temperature of the coolant at the output side depends on a variety of factors (speed of flow, melting grill temperature, type of coolant, etc.). It may typically lie in the region between 40° C. and 90° C.

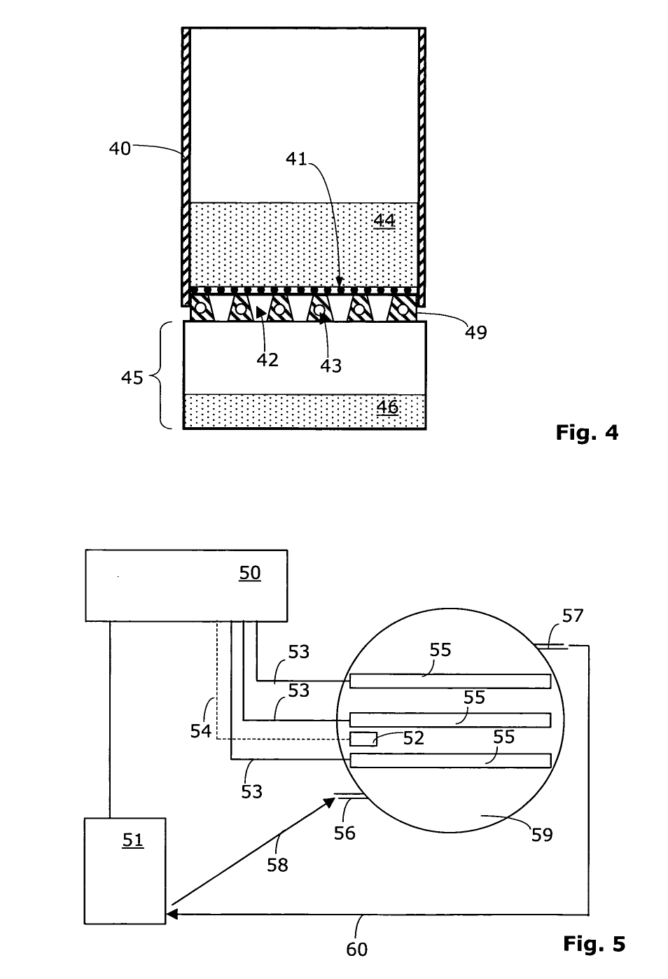

In another form of embodiment, the storage unit 15 is preferably provided with a level sensor 24 (see FIGS. 3 and 4), to detect the filling level in the reservoir 21.

By means of the arrangement described, it is possible to melt a small proportion of the medium, the melting device heating the medium locally in the neighbourhood of the grill 19. A proportion of the molten part of the medium passes through the passageways 20. In the embodiment shown, a storage unit 15 is situated under the container 10 and the grill 19. The storage unit 15 is provided with a reservoir 21, into which the molten medium flows. To ensure that no more than the desired quantity of medium flows into the storage unit 15, the melting device can be switched off. Since heat remains in the system (storage unit 15, grill 19, container 10 and medium), switching off in a controlled manner is not possible in known systems. In order to circumvent this problem, the invention provides for inclusion of a cooling device in the region of the passageways 20. In this embodiment, liquid coolant is led directly through one or more channels 28 of the grill 19 to cool the zone of the passageways 20. The heat is carried away from the grill 19 and the melting procedure is discontinued in a controlled manner. In this way, the viscosity of the medium in this zone is raised again, while no more medium passes into the storage unit 15. No cross-linking occurs in the medium and no harmful vapours are released, as the medium can be kept below the critical temperature by the cooling device.

In the embodiment according to FIGS. 1 to 3, the melting device takes the form of a grid 19 with heating cartridges 25 and the cooling device takes the form of one or more flow channels 28 constructed inside the grid 19. The melting device and the cooling device are thus both incorporated in the grid 19, or connected to this grid 19.

Further characteristics and elements of the system shown in FIGS. 1 to 3 are described below. These characteristics and elements are optional and can be included to improve the system, or to modify the possibilities for application. A pivoting cover 11 is provided with which the container 10 can be covered. The pivoting cover 11 is mounted in such a way that it can be pivoted about a vertical axis of rotation 13. The pivoting cover 11 should preferably be of diameter D2, only slightly smaller than the internal diameter D1 of the container 10, as shown in FIG. 2. The cover 11 should preferably be provided on its upper side with a pivoting arm 30 incorporating a recess 31 at one end. When the cover 11 is closed, this recess 31 engages with a closing mechanism 29 positioned on one side of the container 10. This type of pivoting cover 11 facilitates rapid, easy cleaning of the container 10.

In the embodiment shown, an inliner press 12 is fitted over the cover 11. This press 12 can be so arranged that it exerts controlled pressure from above on the cover 11. By this means, pressure can be applied to the medium in the container 10. This inliner press 12 can preferably be equipped with a pneumatic cylinder. A displacement sensor may also be incorporated or fitted, which is being considered when designing a control unit.

The cover 11 may be equipped with a follower plate 33 (see FIG. 2) located under the cover 11 and provided with a sealing means to form a seal between the follower plate 33 and the inner surface of the container 10. A suitable sealing means is described in published European patent application EP 943583-A1. The sealing means for the follower plate of the system can be so designed as to incorporate an inflatable sealing element. In its inflated state, the sealing element forms the sealing means and lies in contact with the inner surface of the container. It thus constitutes a flexible seal that can be pressed against the surface. With this type of cover 11, a closed, airtight system can be achieved. Depending on circumstances, this may be desirable or even prescribed by regulations, in the case of noxious media.

The system may also include, for example, a motor 16 connected to a pump unit 32 in the region of the storage unit 15 via a shaft 17 and a coupling 18. This pump unit 32 impels the melted medium out of the zone 22 of the reservoir 21, when the motor 16 is running and coupled. The pump unit 32 impels the medium through an optional filter 23 out of the storage unit 15. As an example, a heated hose may be connected to the storage unit 15, through which the medium can be pumped to the application device (for example, in the form of a glue gun or an application nozzle). The pump unit 32 should preferably be a gear pump. The filter 23 can advantageously be provided with a pressure relieve valve.

Another device for use in a system that processes a medium according to the invention is shown schematically in cross-section in FIG. 4. The apparatus shown includes a container 40 to receive the medium 44. A melting device 41 is provided as a means of raising the temperature, in order to bring part of the medium 44 into a state of lower viscosity (melting). In the example shown, the melting device is constructed in the form of a melting grid 41 which heats up when an electric current of suitable magnitude is passed through it and releases this heat locally into the medium 44. By means of this heating, part of the medium 44 is brought into a state of lower viscosity (melted). The apparatus is provided with an output zone 49 with several passageways 42. A proportion of the part of the medium 44 with lower viscosity can pass through the passageways 42 and is received in a storage unit 45. In the embodiment shown, the output zone 49 is provided with several channels 43 through which a gas or fluid can flow and thus cool the output zone 49, at least in the neighbourhood of the passageways 42. In the form of embodiment according to FIG. 4, the melting device is designed in the form of a melting grid 41 and the cooling device in the form of flow channels 43 realized in the output zone 49. The melting device and the cooling device are also constructed separately, both elements being preferably positioned side by side in order to facilitate reliable operation.

Further characteristics and elements of the system shown in FIG. 4 are described below. These characteristics and elements are optional and can be included to improve the system, or to modify the possibilities for application. A cover or a follower plate may be provided, with which the container 40 can be covered above the medium 44. The cover may be mounted, for example, so that it can pivot, or on a hinge. A cover or a follower plate enables fast and simple cleaning of the container 40.

The embodiment according to FIG. 4 may be equipped with a press. This press can be so designed that controlled pressure can be exerted from above on the medium 44. This press should preferably be equipped with a pneumatic cylinder. A displacement sensor may also be incorporated or fitted, which is being considered when designing a control unit.

The cover or follower plate, if present, may be equipped with a sealing means, to form a seal against the inner surface of the container 40. A suitable sealing means is described in published European patent application EP 943583-A1 mentioned above. With this sort of seal, a closed, airtight system can be achieved. Depending on circumstances, this may be desirable or even prescribed by regulations, in the case of noxious media.

The system according to FIG. 4 may include a pumping device to impel molten medium 46 out of the storage unit 45. The pumping device may be equipped, for example, with a filter and a pressure relieve valve.

FIG. 5 shows a block diagram of a combined melting and cooling device. The elements in this drawing may be included as a whole or individually. A control unit 50 is provided, connected to three heating cartridges 55 via conductors 53. The heating cartridges 55 are incorporated in a melting grill 59. In addition to the heating cartridges 55, the grill 59 is traversed inside by one or more cooling channels, not visible in FIG. 5. The cooling channels can be supplied with fluid or gas through an inlet 56. At the other side of the system, an outlet opening 57 is provided. A circulating cooler 51 can preferably be provided to remove the heat from the fluid or gas after this has flowed through the grill 59. The circulating cooler 51 may be provided, for example, with Peltier elements, a refrigeration compressor or an air/water heat exchanger, or it may be an air cooler that pumps gas through the cooling channels. The connection between the circulating cooler 51 and the inlet 56 is effected by means of a tube or hose 58. The fluid or gas returns via a tube or hose 60. In order to realize a control unit, the grill 59 is provided with at least one temperature sensor 52. The sensor 52 is connected to the control unit 50 by means of a line 54.

The circulating cooler 51 may be equipped, for example, with an air/water heat exchanger 62, as shown schematically in FIG. 7. In the example shown, the cooling device includes a tank 64 which contains the coolant 63. A pump 61 impels water 63 out of the tank 64 through a pipe 58 and one or more channels in a grill 59. There the water takes heat from the grill 59. This heats the water, which is then taken through a pipe 60 to a heat exchanger 62 with the largest possible surface area, for example in the form of cooling fins. The heat exchanger 62 extracts the heat energy from the water and dissipates it in the ambient air. The heat exchanger 62 may be equipped with a fan, for example. When the water has been cooled, it is returned via a spout 65 into the tank 64. The pump 61 may, for example, be switched on and off by the control unit 50. The control unit 50 should preferably include control of the pump, making it possible to vary the throughput capacity of the pump 61 according to need.

The control unit 50 should preferably be provided with variable electric current sources so as to allow current of appropriate magnitude to flow through the conductors 53 in the heating cartridges 55.

The control unit 50 should preferably be externally programmable. Programming may be carried out by means of a computer which controls the entire system. The control unit 50 may also comprise its own microprocessor which takes over control functions and controls the procedure according to the invention.

The control unit 50 can also be designed to switch on the heating cartridges in the neighbourhood of the storage unit 15 or 45. A temperature sensor should also preferably be located in the storage unit 15 or 45.

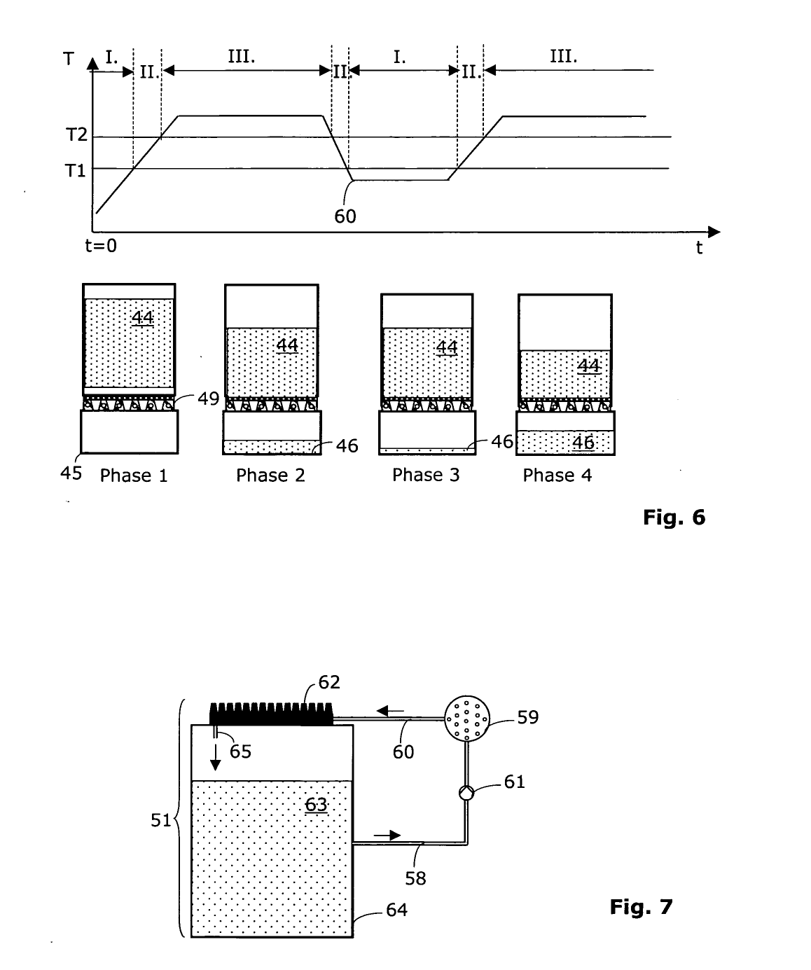

The working of the control unit will now be described with reference to an example shown in FIG. 6. Different phases 1 to 4 are shown in FIG. 6. Below the temperature diagram, an apparatus according to the invention is schematically represented, for the purpose of describing the different states. The curve 61 represents the temperature of a medium in the output zone as a function of the time t.

At time t=0, the medium 44 in the apparatus is solid or pasty. The control unit 50 activates the heating cartridges 55 via the conductors 53 in order to raise the temperature of the medium 44 (Period I.) During this Phase 1, the apparatus is started and the storage unit 45 is empty. The medium 44 has a temperature band between T1 and T2 in which it begins to melt. In the case of PUR, T1 should preferably be approx. 45° C. and T2=85° C. In order to enable reliable operation of the apparatus, the control unit 50 in the embodiment shown is designed to attain temperatures in excess of T2, in order to induce melting. During Period II, the temperature of the medium 44 is steadily increased until it exceeds T2. Part of the medium 44 is now capable of flowing, and it flows through the grill 49 into the storage unit 45 (Phase 2). In Period III a proportion of the molten medium 44 flows out into the storage unit 45. The filling level in the storage unit 45 can be measured with a sensor, for example. As soon as a proportion of the medium is present as medium capable of flowing 46 in the storage unit 45, the control unit 50 switches the melting device off and the cooling device on. During the transition Period II, a portion of the medium 44 is thus reduced again to a pasty, viscously flowing or even solid state, and no medium flows out of the container into the storage unit 45. During Period I, the melting process is interrupted, at least temporarily. Medium 46 can be taken out of the storage unit 45. This reduces the quantity of molten medium 46 in the storage unit 45, shown as Phase 3 in the figure. A sensor now detects the fact that the quantity of molten medium 46 in the storage unit 45 is no longer sufficient to meet requirements. A fresh melting process is now initiated (Period II), in which the heating cartridges 55 are switched on. During Period III, molten medium 46 thus flows into the storage unit 45 again (Phase 4).

The representation shown is given as an example to clarify a preferred embodiment of the invention. It is possible to design the control unit differently.

In a preferred form of embodiment, the control unit 50 is designed so that no temperatures in excess of a critical temperature are generated. The critical temperature for PUR, for example, can be set at approx. 160° C.

In another form of embodiment, the storage unit 45 is preferably provided with a level sensor (not shown in FIG. 4 ) capable of detecting the filling level in the reservoir. The level sensor can constitute a component in a level regulation system with which the level can be controlled and steps can be taken to melt additional medium 44, or to stop the melting process by switching on the cooling device. In another embodiment, the level sensor can be adjusted by being turned and screwed tight. In this way, it is possible, before putting the system into operation, to set the quantity of medium that must be present in the reservoir before the sensor is actuates.

In another form of embodiment, the medium is supplied in a bag, typically made of aluminium (inliner packing). The bottom of the bag is removed and the bag, together with the medium, is placed in the container 10 or 40. The cover 11, if present, is then closed. When medium in the lower part of the container 10 or 40 is melted and extracted, the press, if any, presses downwards. By this means the bag in the lower part of the container 10 or 40 is pressed together and forms a sort of collar which acts as a seal against the inner surface of the container 10 or 40.

The container 10 or 40 is preferably provided with a hinge (not shown in the Figures) and with quick fasteners 14 (see FIG. 1). When the quick fasteners 14 are undone, the container 10 or 40, together with its cover 11, if present, can be swung away about a horizontal axis, the position of which is determined by the hinge. By this opening operation, thorough cleaning of the container and the grill is possible.

The systems can optionally be provided with a back-flow device, in order to return unused medium to the storage unit 15 or 45.

In another embodiment, the grill 19 or 49 is made removable. This facilitates its cleaning or its replacement with another grill.

The grill 19 or 49 should preferably be made from a material which is a good conductor or distributor of heat. The upper surface of the grill should always be, as far as possible, at an even temperature all over. The grill must also display adequate mechanical stability and should not be distorted by variations in temperature. The material of the grill should store as little energy (quantity of heat) as possible, since this would otherwise extend cooling time. Aluminium, copper and light alloys of either or both are particularly suitable.

The grill is typically between 150 mm and 500 mm in total thickness. The diameter of the passageways is strongly determined by the requirements of the medium to be melted.

The storage unit 15 or 45 is preferably provided with means for heating, in order to ensure that the medium in the reservoir does not solidify. Additionally, or alternatively, the storage unit 15 or 45 can be insulated.

The heating device can be constructed in a wide variety of different ways. Preferably, heating by resistances is used. For example, the heating cartridges can contain heating elements which can be heated to the desired degree by an electric current of corresponding magnitude. The heating elements should preferably be made of ceramic material, or enclosed in metal sheaths. Resistive lines or similar, which heat up when current is conducted through them, may also be applied to the grill. As shown in FIG. 4, the melting device can also include a grill 41 or similar construction, provided with wires that heat up when current is applied to them.

Instead of a cooling device operating by means of a gas or fluid, the apparatus can also be provided with Peltier elements directly in the passageway zone. By suitable control of the Peltier elements, the passageway zone can then be heated and cooled in a controlled manner.

A medium capable of flowing, which, in the context of this description, should be taken to include media with temperature-dependent viscosities, and thus also pastes, is a medium which has to be heated to a sufficient temperature to attain a degree of fluidity enabling it then to be dispensed.

According to the invention, the following process is applied when a specified proportion of the solid or pasty medium is required:

Interrogation by means of level monitoring or level indication as to whether sufficient molten medium (e.g. adhesive in fluid state) is present in the storage unit,

If so, extraction of medium out of the storage unit and, depending on need, refilling of the storage unit with molten medium,

If not, local heating of the solid or pasty medium in the container by means of the heating device, in order to reduce the viscosity of the medium to the point where it flows out through one or more passageways into the storage unit,

During the heating process, repeated interrogation by means of level monitoring or level indication as to whether sufficient molten medium is still present in the storage unit,

If so, deactivation of the heating device and activation of the cooling device, in order to hinder or reduce further melting of medium.

Ideally, the process is so designed that the medium in the passageway zone is kept at just under the melting point or just over melting point, in order to avoid the need to supply energy to or extract energy from the system unnecessarily.

Another embodiment of the process according to the invention is characterized in that the subsequent melting of medium by the melting device is controlled through the rotational speed of the gear pump. This rotational speed is the result of the consumption of molten medium. The necessary melting output can thus be determined. In such a regulation system, it is preferable that cylinder pressure, the heating output of the melting device and time should be taken into consideration.

The apparatus and the system according to the invention can be so designed that quantities of medium from only a few grammes to 100 kg/hr can be melted. Systems known up to now are not capable of melting only a few grammes of medium, as the heat energy present in the system invariably induces uncontrolled additional melting. Too much medium is thus melted when small quantities are needed. This drawback is circumvented by the invention.

According to the invention, the apparatus can be cooled down before cleaning.

The invention is particularly suited to the dispensing or processing of adhesive with non-temperature-stable viscosity. Adhesives subject to moisture-induced cross-linking can also be dispensed with no problems by using the procedure according to the invention.

1. Apparatus for use in a system, that dispenses a medium capable of flowing that undergoes a change to a state of lower viscosity in case of an increase in temperature, the apparatus comprising the following:
a container to receive a medium,
a melting device to cause the increase in temperature of a proportion of the medium and alter it to a state of lower viscosity,
an outlet zone with at least one passageway for the part of the medium with lower viscosity, characterized in that
a storage unit is provided for the part of the medium with lower viscosity,
the storage unit is equipped with a level or filling level sensor,
a cooling device) is present for the purpose of enabling active cooling of the outlet zone) and/or the melting device after a proportion of the part of the medium with lower viscosity has passed through the passageway into the storage unit.

2. Apparatus according to claim 1, characterized in that the melting device includes heating cartridges, resistive lines or heating wires that can be heated by electric current.

3. Apparatus according to claim 1 or 2, characterized in that the melting device includes a temperature sensor and a control unit.

4. Apparatus according to claim 1 or 2, characterized in that the outlet zone includes a grill provided with several passageways.

5. Apparatus according to one of the above claims, characterized in that the outlet zone is traversed by at least one channel through which a coolant or gas can flow.

6. Apparatus according to claim 5, characterized in that the cooling device includes a circulating cooler which removes heat from the coolant after the latter has flowed through the outlet zone.

7. Apparatus according to one of the above claims, characterized in that the cooling device and the melting device are separately realized.

8. Apparatus according to claim 1, characterized in that the storage unit is heatable.

9. Apparatus according to one of the above claims, characterized in that the cooling device comprises a refrigeration compressor, heat exchanger or Peltier cooler.

10. System with an apparatus according to one of the above claims, characterized in that the system comprises a pump to impel the part of the medium with lower viscosity.

11. System according to claim 10, characterized in that the system comprises one or more heatable hoses and dispensing devices.

12. System according to claim 10, characterized in that the system comprises a cover with follower plate which can exert pressure on the medium by means of a press, the follower plate preferably being equipped with a flexible joint seal that can be subjected to pressure.

13. System according to one of claims 10 to 12, characterized in that the medium is a polyurethane glue (PUR).

14. Process for dispensing a medium capable of flowing on demand, in which viscous, solid or pasty medium is made available in a container in the following steps:
Interrogation as to whether sufficient medium capable of flowing is present in a storage unit,
If so, extraction of the medium capable of flowing out of the storage unit,
If not, local heating of the viscous, solid or pasty medium in the container by means of a melting device, in order to lower the viscosity of the medium until the latter flows through one or more passageways into the storage unit,
During the heating process, repeated interrogation as to whether sufficient medium capable of flowing is still present in the storage unit,
If so, deactivation of the melting device and activation of a cooling device, in order to hinder or reduce further melting of medium.

15. Process according to claim 14, characterized in that a pump to extract medium capable of flowing from the storage unit is switched on as soon as sufficient medium capable of flowing is present in a storage unit.

16. Process according to claim 14, characterized in that the container is provided with a follower plate which follows the medium down in the container each time medium is extracted.

17. Process according to claim 16, characterized in that the follower plate is provided with a press that exerts pressure on the medium in the container.

18. Process according to claim 17, characterized in that
the press is switched on after the melting device has been switched on, in order to exert pressure on the viscous, solid or pasty medium,
the press is switched to pressure-free mode before the cooling device is switched on.
